(19) United States
(12) Patent Application Publication
(10) Pub. No.: US 2008/0000456 A1
(43) Pub. Date: Jan. 3, 2008

(54) Cost-optimized canister purge valve

(75) Inventor: Russell Miles Modien, Chatham (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Canada Limited, Chatham (CA)

(21) Appl. No.: 11/802,898

(22) Filed: May 25, 2007

Related U.S. Application Data
(60) Provisional application No. 60/806,287, filed on Jun. 30, 2006.

(51) Int. Cl. F02M 33/02

(52) U.S. Cl. 123/520

(57) ABSTRACT

A canister purge valve (14) includes a housing (40) defining a fuel vapor flow path between first and second ports. A seat (68) defines an aperture (66) through which fuel vapor flow passes to the second port in an open configuration of the purge valve and, in a closed configuration of the purge valve, the aperture is occluded and fuel vapor is prevented from passing to the second port. A stator assembly (59) has a coil (58) such that when the coil is energized, a magnetic field is generated. When the coil is de-energized, an armature (64) engages the seat and occludes the aperture in the closed configuration of the purge valve. When the coil is energized, the armature is attracted to the stator assembly and moves away from engagement with the seat in the open configuration of the purge valve.

This application claims the benefit of the earlier filing date of U.S. Provisional Application No. 60/806,287, filed on Jun. 30, 2006, which is incorporated by reference herein in its entirety.

### FIELD OF THE INVENTION

The present invention relates to a solenoid-operated fluid valve for purging volatile fuel vapors from fuel tanks and vapor storage canisters to internal combustion engines that power such vehicles.

### BACKGROUND OF THE INVENTION

A known on-board evaporative emission control system includes a fuel vapor collection canister, which collects volatile fuel vapors from the headspace of the fuel tank, and a canister purge solenoid (CPS) valve for periodically purging collected vapors to an intake manifold of the engine. The CPS valve comprises a solenoid actuator that is under the control of a microprocessor-based engine management system.

Fuel vapors from the tank flow through the vapor line and is stored in the vapor canister. The vapor canister is a storage medium for the hydrocarbon fuel vapors and is filled with carbon which has a natural affinity for hydrocarbons. During vehicle operation, atmospheric air is drawn in through the canister vent and the hydrocarbon vapors are introduced into the engine intake manifold and are mixed with the fuel-air mixture and are burnt in the engine.

There is a need to provide an improved purge valve that optimizes cost through material usage and assembly.

### SUMMARY OF THE INVENTION

An object of the invention is to fulfill the need referred to above. In accordance with the principles of an embodiment of the present invention, a purge valve is constructed and arranged to be mounted in fluid communication between a fuel vapor collection canister and an intake manifold of an internal combustion engine. The purge valve includes a housing defining a fuel vapor flow path between first and second ports. The first port is constructed and arranged to be in fluid communication with the fuel vapor collection canister, and the second port is constructed and arranged to be in fluid communication with the intake manifold. A seat defines an aperture through which fuel vapor flow passes to the second port in an open configuration of the purge valve. In a closed configuration of the purge valve, the aperture is occluded and fuel vapor is prevented from passing to the second port. A stator assembly has a coil such that when the coil is energized, a magnetic field is generated. When the coil is de-energized, an armature engages the seat and occludes the aperture in the closed configuration of the purge valve. When the coil is energized, the armature is constructed and arranged to be attracted to the stator assembly and move away from engagement with the seat in the open configuration of the purge valve.

In accordance with another aspect of the invention, a method of assembling a purge valve is provided. The purge valve is constructed and arranged to be mounted in fluid communication between a fuel vapor collection canister and an intake manifold of an internal combustion engine. The method includes the step of:
providing a bobbin with wire wound about the bobbin to define a coil, the bobbin defining a passageway,
providing a shell member,
coupling a stator to the shell member,
placing the bobbin with the coil over the stator so that at least a portion of the stator is received in the passageway,
placing the shell member, with stator, bobbin and coil attached, into a body,
placing a spring with respect to a top of the shell member,
placing an armature so as to be biased by the spring, and
coupling a cap to the body.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of an evaporative emission control system provided in accordance with an embodiment of the invention.

FIG. 2 is a view of a canister purge valve of the system of FIG. 1.

FIG. 3 is a sectional view of a portion of the canister purge valve of FIG. 2.

FIG. 4 is a view of a stator-armature assembly of the canister purge valve of FIG. 3.

FIG. 5 is an exploded view of the stator-armature assembly of FIG. 4.

### DETAILED DESCRIPTION OF THE EXEMPLARY EMBODIMENTS

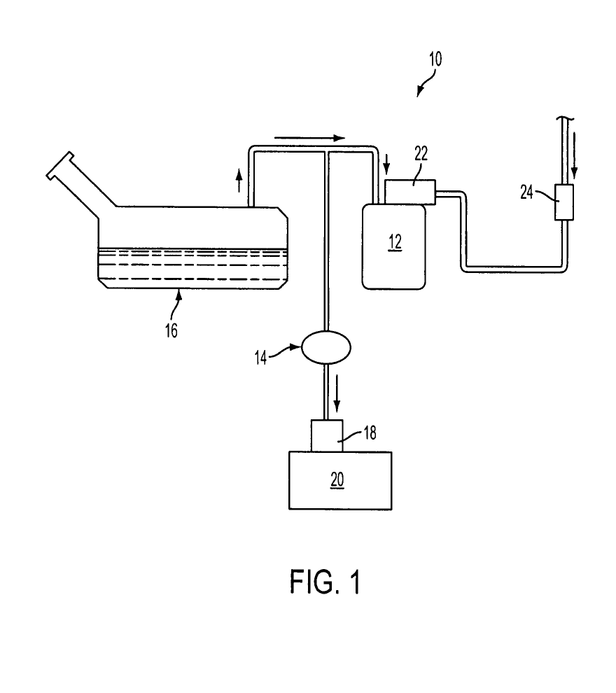

FIG. 1 shows an evaporative emission control system 10 of a motor vehicle comprising a fuel vapor collection canister (e.g., a carbon canister) 12 and a canister purge (CP) valve 14 connected in series between a fuel tank 16 and an intake manifold 18 of an internal combustion engine 20 in a known fashion. A fuel vapor pressure management system 22 is in fluid communication between the fuel vapor collection canister 12 and ambient atmospheric conditions via a filter 24.

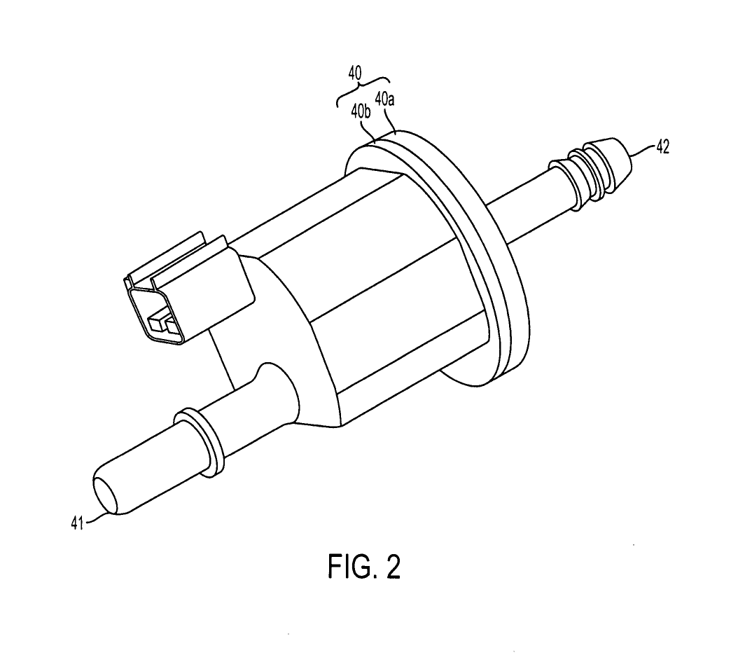

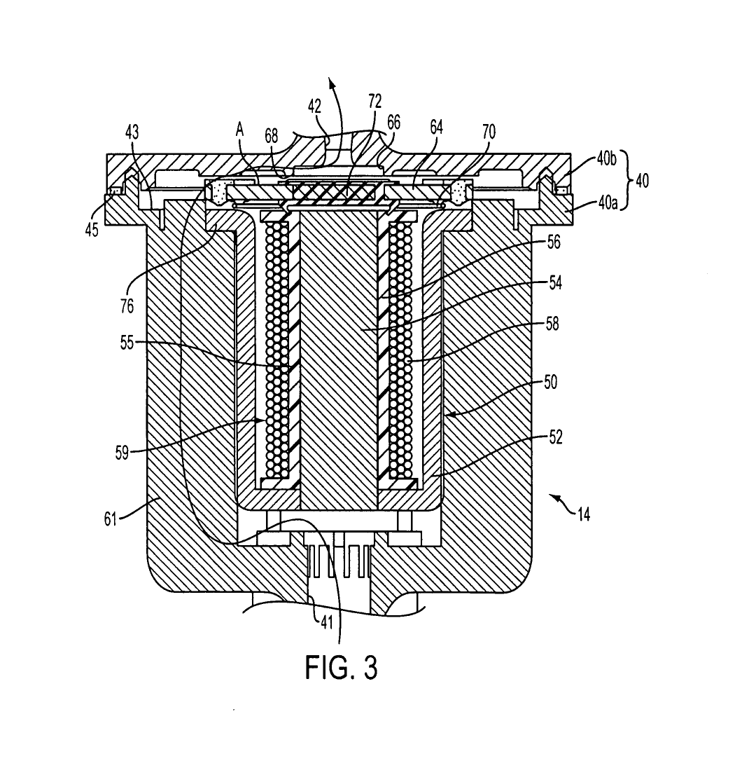

Referring to FIGS. 2 and 3, the CP valve 14 includes a housing 40 that defines an inlet port 41 and an outlet port 42. Preferably, the housing 40 includes a body 40a having an opened end 43 that receives the electromagnetic components of the CPS valve 14. The housing 40 also includes a cap 40b that is cooperatively coupled to the body 40a to close the opened end 43. Of course, the housing 40 can be composed of different numbers and arrangements of pieces. The inlet port 41 (in body 40a) is constructed and arranged to be in fluid communication with the fuel vapor collection canister 12 and the outlet port 42 (in cap 40b) is constructed and arranged to be in fluid communication with the intake manifold 18 of the internal combustion engine 20.

The outlet port 42 portion of the cap 40b may include a sonic nozzle configuration so as to maintain a constant (or sonic) mass flow regardless of changes in vacuum level at the intake manifold 18, down to some minimum level of differential vacuum. The cap 40b may be secured to the body 40a by any conventional manner, such as by one or more fasteners or welding. A gasket or O-ring 45 may be interposed between the body 40a and the cap 40b to ensure that the housing 40 is leak-proof.

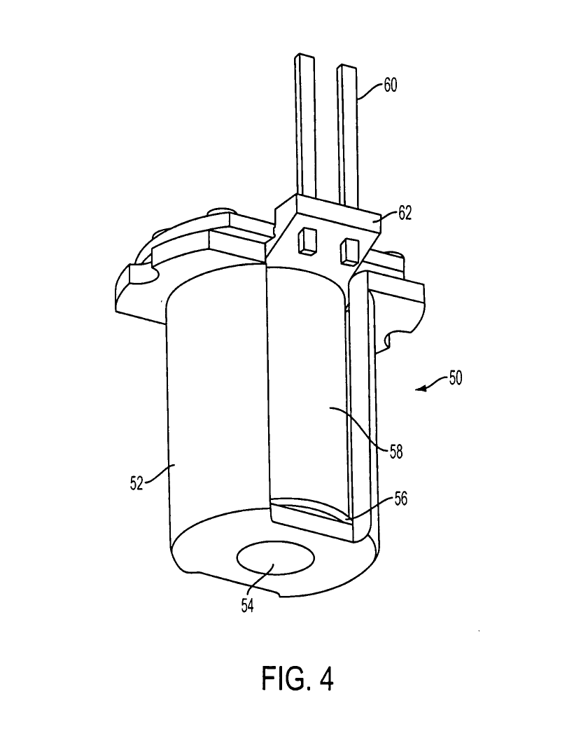

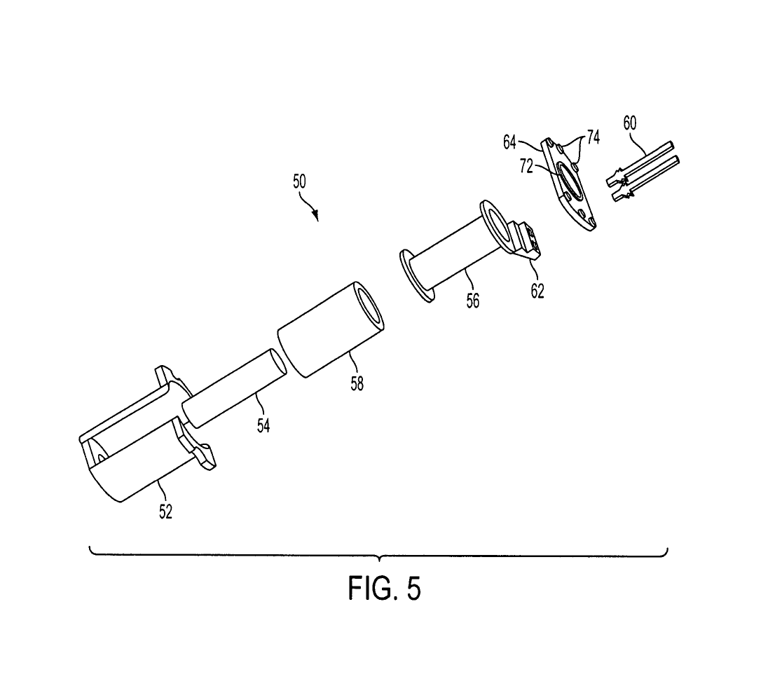

As shown in the exemplary embodiment, the body 40a receives an stator-armature assembly, generally indicated at 50. With reference to FIGS. 3-5, the assembly 50 includes a shell 52 preferably of the stamped strap-type that houses a stator 54. The stator 54 is preferably a solid ferrous, non-machined cylindrical rod that is pressed into the shell 52 to a pre-defined depth and received inside of a passageway 55 of a bobbin 56. The bobbin 56 is preferably of plastic material. A coil 58, preferably of 32 AWG single insulated wire is wound about the bobbin 56. The stator 54, bobbin 56 and coil 58 define a stator assembly, generally indicated at 59. Note that the coil 58 is shown as a cylindrical member in FIG. 5 for ease of illustration. Electrical leads 60 for the coil 58 are associated with portion 62 of the bobbin and extend out through the cap 40a.

An armature 64 is movable with respect to the stator 54. In an open configuration of the CP valve 14, as shown in FIG. 3, fuel vapor is permitted to flow from the first port 41 to the second port 42 around the stator assembly 59 and past aperture 66 (see arrow A in FIG. 3) by virtue of the armature 64 being spaced from a seat 68 provided in the cap 40b and defining the aperture 66. It is noted that the cross-section of FIG. 3 is taken through ribs 61 making the body 40a appear to be solid; however, the body 40a is not solid thus allowing flow as described above. In a closed configuration of the CP valve 14, fuel vapor flow is prevented from the first port 41 to the second port 42 by virtue of the armature 64 occluding the aperture 66, as will be explained more fully below.

The armature 64 includes a ferrous stamping that is magnetically attracted to the stator 54 in the open configuration of the CP valve 14. To move the armature 64 from the closed configuration to the open configuration of the CP valve 14, an electric current is supplied to the coil 58 via the electrical leads 60. The electric current in the coil 58 develops a magnetic field that magnetizes the stator 54. This attracts the armature 64 to the stator 54 (against the bias of an armature spring 70) to define the open configuration of the CP valve 14. When the current supply is disconnected from the coil 58, the magnetic field collapses and the armature spring 70 biases the armature 64 upwardly (away from the stator 54) to engage the seat 68. In the embodiment, the armature 64 includes an elastomer (e.g., rubber) seal 72 that seals against the seat 68. Elastomer stops 74 can also be provided on the armature 64 to reduce travel and limit accoustical vibration in both the open and closed configurations. The stops 74 and seal 72 are shaped to provide increased resistance with travel or gradual deceleration. The armature 64 is preferably a simple stamping with the over-molded rubber seal 72 and rubber stops 74.

To assemble the CP valve 14, the electrical leads 60 are pressed into the bobbin 56. The bobbin 56 is then wound with wire to define the coil 58 and the wire is soldered or welded to the leads 60. The stator 54 is pressed into the shell 52 preferably in interference fit relation. The bobbin 56 with coil 58 is placed over the stator 54 within the shell 52. The shell 52 (with the coil and bobbin) is pressed into the body 40a. The body 4a has features 76 (FIG. 3) to locate shell at the proper height. The armature spring is then placed with respect to the top of the shell 52 or bobbin 56. The armature 64 is then placed into the body 40a. The body 40a and bobbin 56 can include features for axial and rotational alignment of the armature 64. An O-ring seal is provided to seal the terminals. The cap 40b is then welded or otherwise fastened to the body 40a.

Although the stator 54 is shown to be a solid member, the stator 54 can be a hollow tube with vapor flowing through the tube and around the armature 64 to the outlet 42, when the valve 14 is in the open configuration. However, this adds cost to the stator 54 due to machining and may decrease magnetic efficiency.

The above features provide a cost-optimized CP valve 14 based on design, components and assembly factors. For example, the magnetic circuit is configured to reduce the use of copper magnet wire. Each component is of minimal complexity and requires minimal secondary processing. The overall assembly consists of basic process steps.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A purge valve constructed and arranged to be mounted in fluid communication between a fuel vapor collection canister and an intake manifold of an internal combustion engine, the purge valve comprising:
a housing defining a fuel vapor flow path between first and second ports, the first port being constructed and arranged to be in fluid communication with the fuel vapor collection canister, and the second port being constructed and arranged to be in fluid communication with the intake manifold;
a seat, defining an aperture through which fuel vapor flow passes to the second port in an open configuration of the purge valve and, in a closed configuration of the purge valve, the aperture is occluded and fuel vapor is prevented from passing to the second port,
a stator assembly having a coil such that when the coil is energized, a magnetic field is generated, and
an armature engaging the seat when the coil is de-energized and occluding the aperture in the closed configuration of the purge valve, and when the coil is energized, the armature is constructed and arranged to be attracted to the stator assembly and move away from engagement with the seat in the open configuration of the purge valve.

2. The purge valve of claim 1, further comprising a spring biasing the armature towards the seat.

3. The purge valve of claim 1, wherein the armature is of ferrous material with elastomer portion, the elastomer portion engaging the seat in the closed configuration of the purge valve.

4. The purge valve of claim 1, wherein the stator assembly includes a bobbin having a passageway and a stator in the passageway, the coil being disposed about the bobbin.

5. The purge valve of claim 4, wherein the stator is a solid ferrous, cylindrical rod.

6. The purge valve of claim 1, wherein the housing includes a body having an opened end, the stator assembly and armature being received in the opened end, the housing also including a cap coupled to the body and closing the opened end.

7. The purge valve of claim 6, wherein the body defines the first port and the cap defines the second port.

8. The purge valve of claim 7, wherein the seat is integral with the cap.

9. The purge valve of claim 6, further including a shell, the stator assembly being received in the shell, the shell being received in the body.

10. The purge valve of claim 9, wherein the stator assembly includes a bobbin having a passageway and a stator in the passageway, the coil being disposed about the bobbin and an end of the stator being in interference fit relation with a portion of the shell.

11. The purge valve of claim 3, wherein the housing includes a body having an opened end, the stator assembly and armature received in the opened end, the housing also including a cap coupled to the body and closing the opened end, and wherein the armature includes elastomer stops constructed and arranged to engage a portion of the cap under certain conditions.

12. A purge valve constructed and arranged to be mounted in fluid communication between a fuel vapor collection canister and an intake manifold of an internal combustion engine, the purge valve comprising:
a housing defining a fuel vapor flow path between first and second ports, the first port being constructed and arranged to be in fluid communication with the fuel vapor collection canister, and the second port being constructed and arranged to be in fluid communication with the intake manifold;
a seat defining an aperture through which fuel vapor flow passes to the second port in an open configuration of the purge valve and, in a closed configuration of the purge valve, the aperture is occluded and fuel vapor is prevented to pass to the second port,
means for developing a magnetic field, and
means for engaging the seat and occluding the aperture in the closed configuration of the purge valve, when a magnetic field is not developed by the means for developing, and when the means for developing develops a magnetic field, the means for engaging is constructed and arranged to be attracted to the means for developing and move away from engagement with the seat in the open configuration of the purge valve.

13. The purge valve of claim 12, wherein the means for engaging is an armature and a spring biases the armature towards the seat.

14. The purge valve of claim 13, wherein the armature is of ferrous material with elastomer portion, the elastomer portion engaging the seat in the closed configuration of the purge valve.

15. The purge valve of claim 12, wherein the means developing includes a bobbin having a passageway, a stator in the passageway, and a coil disposed about the bobbin.

16. The purge valve of claim 15, wherein the stator is a solid ferrous, cylindrical rod.

17. The purge valve of claim 12, wherein the housing includes a body having an opened end, the means for generating and the means for engaging being received in the opened end, the housing also including a cap coupled to the body and closing the opened end, the cap including the seat.

18. The purge valve of claim 17, further including a shell, the means for developing includes a stator assembly received in the shell, the shell being received in the body.

19. The purge valve of claim 18, wherein the stator assembly includes a bobbin having a passageway, a stator in the passageway, and a coil disposed about the bobbin, an end of the stator being in interference fit relation with a portion of the shell.

20. A method of assembling a purge valve constructed and arranged to be in fluid communication between a fuel vapor collection canister and an intake manifold of an internal combustion engine, the method comparing:
providing a bobbin with wire wound about the bobbin to define a coil, the bobbin defining a passageway,
providing a shell member,
coupling a stator to the shell member,
placing the bobbin with the coil over the stator so that at least a portion of the stator is received in the passageway,
placing the shell member, with stator, bobbin and coil attached, into a body,
placing a spring with respect to a top of the shell member,
placing an armature so as to be biased by the spring, and
coupling a cap to the body.
